(19) United States
(12) Patent Application Publication
(10) Pub. No.: US 2013/0341918 A1
(43) Pub. Date: Dec. 26, 2013

(54) Faucet Fast Connector

(71) Applicant: Yu-Ching YEH, Lukang Township (TW)

(72) Inventor: Yu-Ching YEH, Lukang Township (TW)

(21) Appl. No.: 13/529,397

(22) Filed: Jun. 21, 2012

(51) Int. Cl. F16L 19/00

(52) U.S. Cl. 285/355; 285/335

(57) ABSTRACT

A faucet fast connector comprises a connecting part and an outflow part. The connecting part includes a plate used to allow water inflow and configure through holes. The outflow part includes an accommodating element having a stopper to allow an end of an elastic element to abut against, an accommodating area inside the accommodating element, a gasket located in the accommodating area and having a flow guide hole for forming displacement with the through hole, a blocking element located on the other side of the elastic element and corresponding to the gasket, and an air hole located under the accommodating area and connected in communication with the inside and outside of the accommodating element. Exterior air can enter into the air hole to drain out the water remaining in the outflow part thereby preventing frozen water problems under low temperature.

### BACKGROUND OF THE INVENTION

1. Field of the Invention

The present invention discloses a fast connector; in particular, the present invention discloses a faucet fast connector capable of preventing frozen water problems under low temperature to provide normal water supply.

2. Description of Related Art

It is common that, upon using water from a faucet, a user may install a faucet fast connector to the faucet and further directly sleeve joint a water pipe to the faucet fast connector so that the user can guide the water flow to a remote location for applications.

Certainly, when the surrounding temperature drops down under zero degree centigrade, the water remaining within the aforementioned faucet fast connector may freeze thus leading to water outflow blockage from the faucet fast connector.

### SUMMARY OF THE INVENTION

The objective of the present invention is to provide a faucet fast connector to prevent frozen water problems under low temperature thereby allowing normal water supply.

To achieve the above-said objective, the faucet fast connector according to the present invention comprises:

a connecting part, including a plate which can be detachably installed to a faucet to allow water inflow and is configured with at least a through hole at its bottom edge; and

an outflow part, including an accommodating element configured along with the connecting part to form a connection and internally having a stopper to allow an end of an elastic element to abut against, an accommodating area formed inside the accommodating element to constitute a gap between the plate, a gasket located in the accommodating area and having a flow guide hole for forming displacement with the at least a through hole, a blocking element located on the other side of the elastic element to correspond to the gasket, and at least an air hole located under the accommodating area to maintain a space and connected in communication with the inside and outside of the accommodating element.

The benefits of the present invention lie in that, between the air hole and the gasket, it is possible to allow exterior air to consistently enter into the outflow part, and the air flows due to the internal and external pressure difference inside the outflow part, so that remained water therein can be drained out to prevent frozen water problems under low temperature, thereby effectively sustaining normal water flow from the faucet as well as assemblies and/or tools sleeve jointed to the faucet thereafter.

### BRIEF DESCRIPTION OF THE DRAWINGS

FIG. 1 shows a stereo view illustrating an assembly perspective of an embodiment according to the present invention;

FIG. 2 shows a cross-section view illustrating the internal structure of FIG. 1;

FIG. 3 shows a stereo disassembly view illustrating the allocation relationships for each of the components in FIG. 1;

FIG. 4 shows a cross-section view illustrating the structure of the accommodating element in the outflow part of FIG. 3;

FIG. 5 shows a cross-section view illustrating the structure of the plate and the locking element in the connecting part of FIG. 3;

FIG. 6 shows a cross-section view illustrating the movement of the blocking element in FIG. 2;

FIG. 7 shows a cross-section view illustrating the blocking element of FIG. 2 allows water to continuously flow out from the outflow part; and

FIG. 8 shows a cross-section view illustrating, as the blocking element of FIG. 2 located at its original position before movement, external air may spontaneously enter into the air hole to drain out the water remaining in the outflow part thereby preventing frozen water problems under low temperature.

### DETAILED DESCRIPTION OF THE PREFERRED EMBODIMENTS

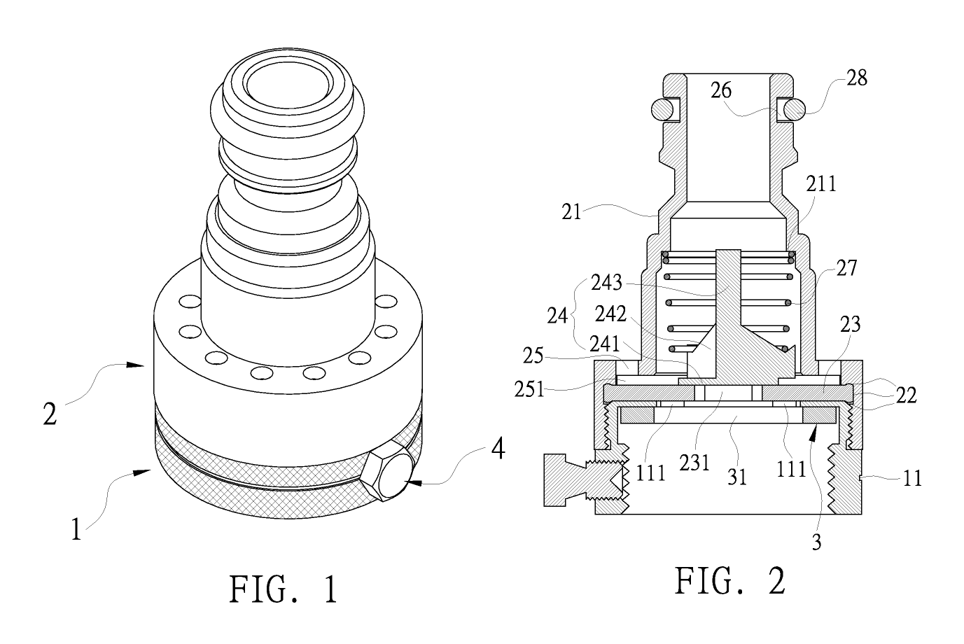

FIG. 1 shows an embodiment of the faucet fast connector according to the present invention, comprising a connecting part 1 and an outflow part 2.

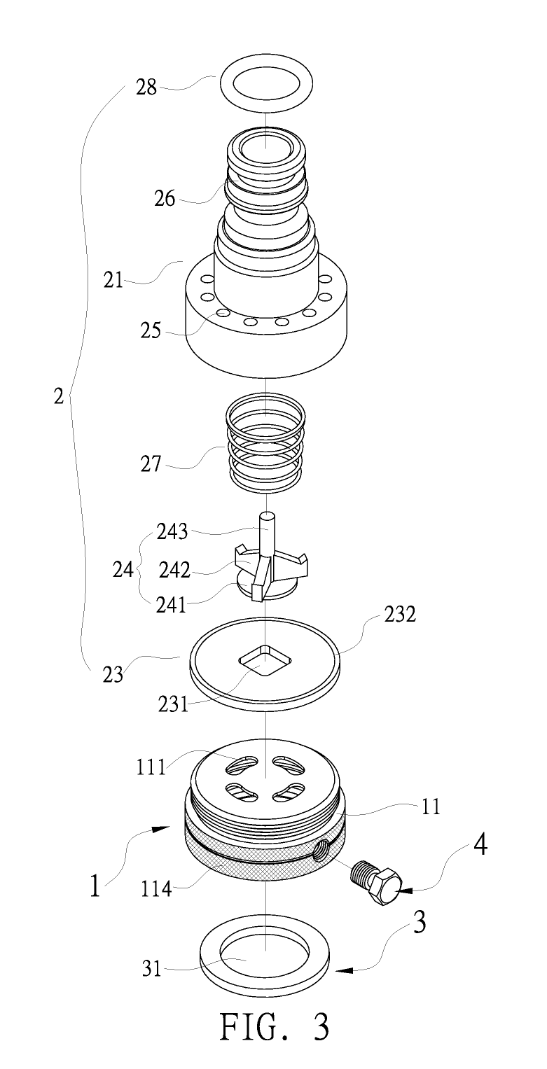

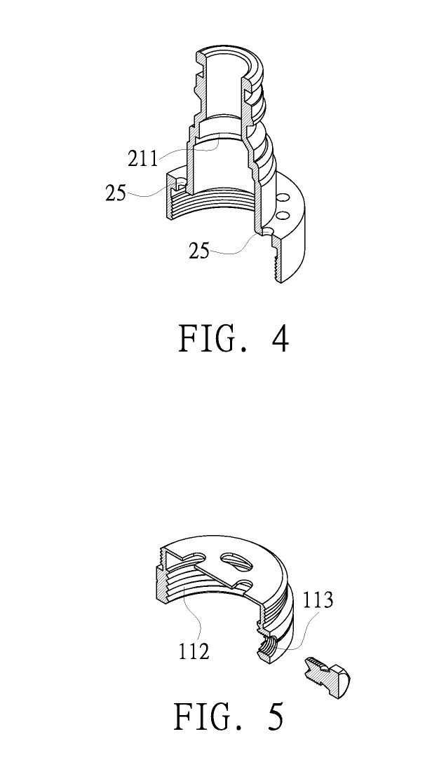

In conjunction with FIGS. 2 to 5, it can be seen the above-said connecting part 1 includes a plate 11 used to be detachably installed to the faucet 6 for water inflow and configured with at least a through hole 111 at the bottom edge thereof.

Herein the peripheral surface on the inner edge of the plate 11 in the connecting part 1 is formed with a screw thread section 112 for screw connection. The outer periphery of the upper half in the connecting part 1 is configured with a slide blocking area 114 which can be pressed down to prevent sliding when the user operates and facilitate connection tightness as jointed with other objects or assemblies.

The present embodiment also includes a washer 3 installed along the peripheral surface on the inner edge and the bottom surface of the plate 11, in which the washer 3 allows precise correspondence to the faucet 6 such that water in the faucet 6 can precisely flows into the plate 11 and the sealing between such two elements can be enhanced to prevent water leakage. The inside of the washer 3 has a surrounding space 31 corresponding to the at least a through hole 111, in which the surrounding space 31 is connected in communication with the at least a through hole 111, and the surrounding space 31 allows the water inflow from the faucet 6 to pass the at least a through hole 111 and further move toward the direction of the gasket 23. In the present embodiment, the number of the at least a through hole 111 is four, but it is by no means limited thereto.

A connectable screw hole 113 is configured on the plate 11 along the direction parallel to the washer 3, in which the screw hole 113 is used to install a locking element 4 so as to hang a suspension element (not shown) of the locking element 4 onto the faucet 6, and the screw hole 113 is located inside the slide blocking area 114.

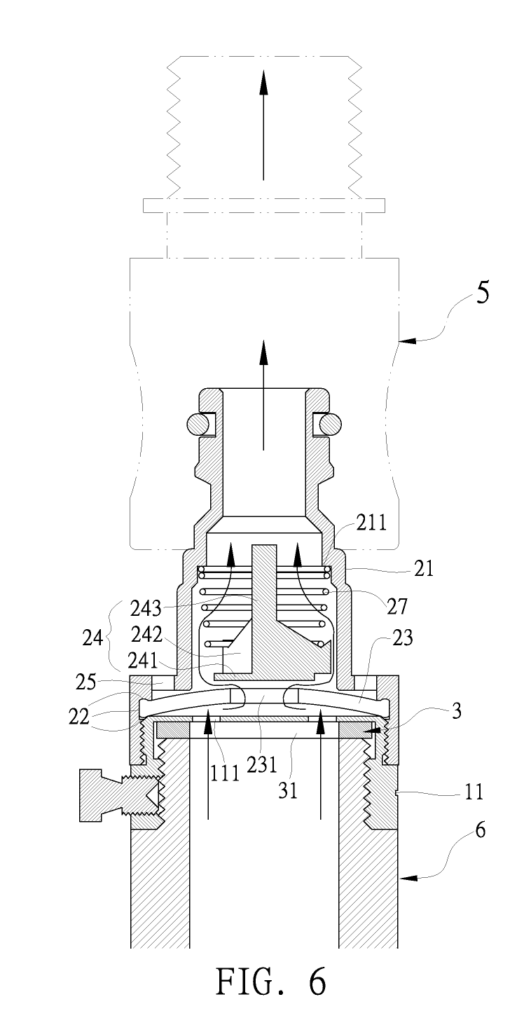

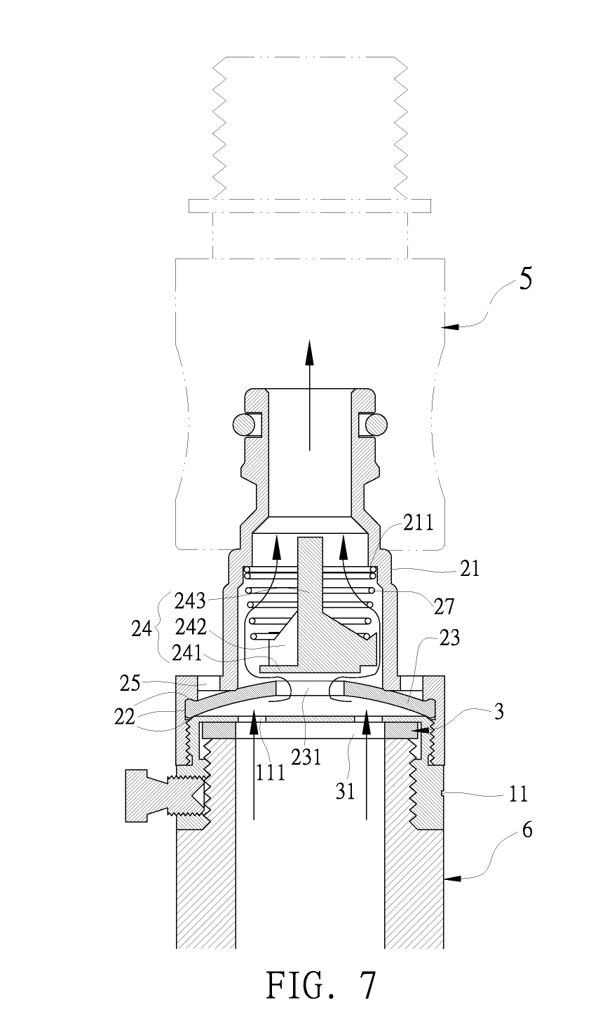

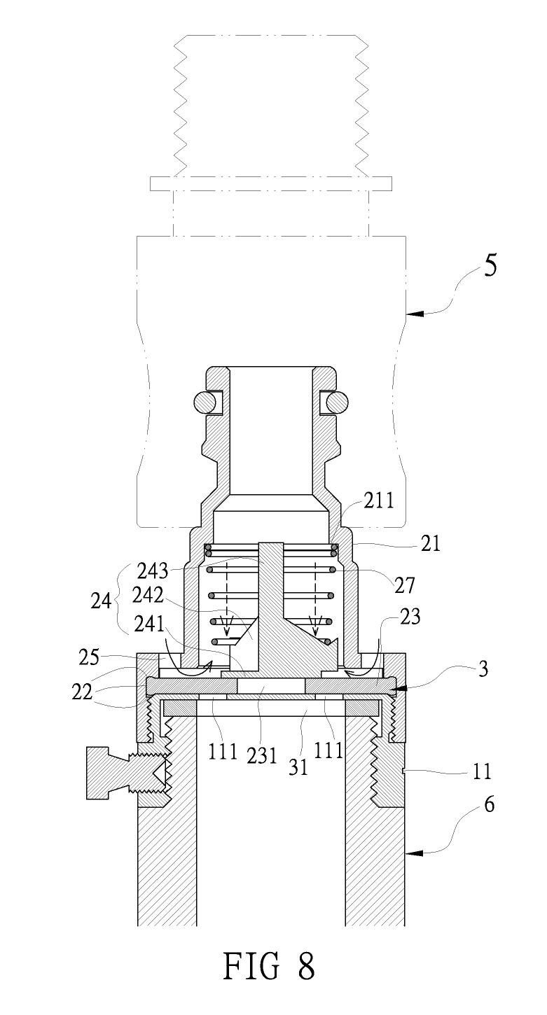

Refer now conjunctively to FIGS. 6 and 7, the aforementioned outflow part 2 includes an accommodating element 21 configured along with the connecting part 1 to form a connection and internally having a stopper 211 to allow an end of an elastic element 27 to abut against, an accommodating area 22 formed inside the accommodating element 21 to constitute a gap between the plate 11, a gasket 23 located in the accommodating area 22 and having at least a flow guide hole 231 for forming displacement with the at least a through hole 111, a blocking element 24 located on the other side of the elastic element 22 to correspond to the gasket 23, and at least an air hole 25 located under the accommodating area 22 to maintain a space 251 and connected in communication with the inside and outside of the accommodating element 21.

Herein the upper and lower sides in the peripheral edge of the gasket 23 are respectively formed with a leakage blocking edge 232 having a certain height, and the leakage blocking edge 232 surrounds in closure the peripheral edge of the gasket 23. The height of the leakage blocking edge 232 may act to enhance the tightness with adjacent contact portions; in particular, after assemblage of the plate 11 and the accommodating element 21, once the tightness between the leakage blocking edge 232 and the accommodating area 22 is increased, the water flow and the entry of exterior air can be well guided toward the predetermined direction.

The blocking element 24 includes a plate surface 241 allowable for overlapping in pressure on the at least a flow guide hole 231, at least three flow guide boards 242 ring-wise allocated in separation toward the direction of the elastic element 27 from the plate surface 241 and individually operable to hook on the other end of the elastic element 27, and a raised section 243 concentrated from the ends of the flow guide boards 242 and then forwardly extending. The raised section 243 and the most of the flow guide boards 242 are located inside the elastic element 22, while a small part of the flow guide boards 242 is outside the elastic element 22.

The blocking element 24 has a final position, and upon located at this position, the elastic element 27 is compressed to its limit.

The outflow part 2 can be further sleeve jointed with a pipe fast connector 5. Herein the exterior periphery of the outflow part 2 includes a peripheral recessed area 26 used for sleeve jointing to a leakage blocking ring 28, in which the leakage blocking ring 28 can fill up the aperture between the outflow part 2 and the pipe fast connector 5. In addition, one end of the pipe fast connector 5 can be further bound to pipe (not shown).

In operation, as shown in FIGS. 1 to 7, when the surrounding temperature is above zero degree centigrade, with the faucet fast connector of the present embodiment, the user turns on the control switch (not shown) of the faucet 6 to allow water to flow into the faucet fast connector. At this moment, water flows to the at least a through hole 111 to impact the gasket 23 thereby generating a water flow path. The above-said water will now continue to flow toward the at least a flow guide hole 231 so as to cause the movement of the blocking element 24 thus further forming the water flow path thereby allowing water to exit from the outflow part 2. On the other hand, in case the user turns off the control switch of the aforementioned faucet 6, the blocking element 24 will be located at the original position before movement so exterior air may spontaneously enter into the at least an air hole 25, such that, between the at least an air hole 25 and the gasket 23, it is possible all the time to allow exterior air to consistently flow into the outflow part 2. Therefore, the embodiment can be adapted to various environmental conditions and climates to maintain a vacuum status in the areas between the gasket 23 and the faucet 6, but always allow communications with exterior air in the portions of the outflow part 2 below the gasket 23, the pipe fast connector 5 as well as the pipe (not shown). As such, even the surrounding temperature drops down below zero degree centigrade, it is still possible to drain out water remaining in the outflow part 2 to prevent frozen water problems such that the faucet 6 can keep normal water supply.

Although the present invention has been set forth in details by means of the aforementioned preferred embodiments, the descriptions are intended to allow those skilled ones in the art to better understand the present invention rather than limiting the scope of the present invention thereto. Therefore, all effectively equivalent changes and modifications made in accordance with the profiles, structures, characteristics and spirit described in the claims of the present invention are deemed as falling within the scope of the present invention.

### MAJOR COMPONENT SYMBOL DESCRIPTION

1 Connecting Part
11 Plate
111 Through Hole
112 Screw Thread Section
113 Screw Hole
114 Slide Blocking Area
2 Outflow Part
21 Accommodating Element
211 Stopper
22 Accommodating Area
23 Gasket
231 Flow Guide Hole
232 Leakage Blocking Edge
24 Blocking Element
241 Plate Surface
242 Flow Guide Board
243 Raised Section
25 Air Hole
251 Space
26 Peripheral Recessed Area
27 Elastic Element
28 Leakage Blocking Ring
29 Washer Body
3 Washer
31 Surrounding Space
4 Locking Element
5 Pipe Fast Connector
6 Faucet

What is claimed is:

1. A faucet fast connector, comprising:
a connecting part, including a plate which can be detachably installed to a faucet to allow water inflow and is configured with at least a through hole at its bottom edge; and
an outflow part, including an accommodating element configured along with the connecting part to form a connection and internally having a stopper to allow an end of an elastic element to abut against, an accommodating area formed inside the accommodating element to constitute a gap between the plate, a gasket located in the accommodating area and having a flow guide hole for forming displacement with the at least a through hole, a blocking element located on the other side of the elastic element to correspond to the gasket and having an initial position, and at least an air hole located under the accommodating area to maintain a space and connected in communication with the inside and outside of the accommodating element.

2. The faucet fast connector according to claim 1, wherein the peripheral surface on the inner edge of the plate in the connecting part is formed with a screw thread section.

3. The faucet fast connector according to claim 2, further comprising a washer installed along the peripheral surface on the inner edge and the bottom surface of the plate, and the inside of the washer has a surrounding space corresponding to the at least a through hole.

4. The faucet fast connector according to claim 3, wherein a connectable screw hole is configured on the plate along the direction parallel to the washer, and the screw hole allows installation of a locking element in order to hang a suspension element of the locking element on the faucet.

5. The faucet fast connector according to claim 4, wherein the exterior periphery in the upper portion of the connecting part is configured with a slide blocking area and the screw hole is located within the slide blocking area.

6. The faucet fast connector according to claim 5, wherein the upper and lower sides in the peripheral edge of the gasket are respectively formed with a leakage blocking edge having a certain height, and the leakage blocking edge surrounds in closure the peripheral edge of the gasket.

7. The faucet fast connector according to claim 6, wherein the blocking element includes a plate surface allowable for overlapping in pressure on the at least a flow guide hole, at least three flow guide boards ring-wise allocated in separation toward the direction of the elastic element from the plate surface and individually operable to hook on the other end of the elastic element, and a raised section concentrated from the ends of the flow guide boards and then forwardly extending.

8. The faucet fast connector according to claim 7, wherein the blocking element has a final position, and, at the final position, the elastic element is compressed to its limit.

9. The faucet fast connector according to claim 8, wherein the outflow part can be further sleeve jointed to a pipe fast connector.

10. The faucet fast connector according to claim 9, wherein the exterior periphery of the outflow part includes a peripheral recessed area for sleeve jointing to a leakage blocking ring, in which the leakage blocking ring can fill up the aperture between the outflow part and the pipe fast connector.

11. The faucet fast connector according to claim 4, wherein an end of the pipe fast connector can be sleeve jointed to a pipe.
